(19) United States
(12) Patent Application Publication
(10) Pub. No.: US 2026/0325273 A1
(43) Pub. Date: Oct. 22, 2026

(54) CAD-CAM method of mandibular movement transfer to generate individualized 3D printed trajectory guides

(71) Applicant: Wendy Crystal GONZALEZ MURILLO, CUAUHTEMOC CHIHUAHUA (MX)

(72) Inventor: MARCO EDREY GONZALEZ MURILLO, CUAUHTEMOC CHIHUAHUA (MX)

(21) Appl. No.: 19/108,726

(22) PCT Filed: Sep. 5, 2022
(86) PCT No.: PCT/MX2022/050072

§ 371 Date: Mar. 4, 2025

(51) Int. Cl. A61C 11/06

(52) U.S. Cl. CPC A61C 11/06

(57) ABSTRACT

This patent refers to a computerized digital method (CAD-CAM) to obtain guides of the trajectories of the jaw movements obtained from each patient integrated into digital predetermined abutments, which can be printed in 3D and integrated into the already known dental articulators. Individualizing the jaw movements synchronized to the dental movements by the already known methods of device tracking using cameras or 3D scanners integrated into software, through CBCT and dental scanning. Through the alignment and individualization of components with the use of specialized software.

### OBJECT OF THE INVENTION

The present invention aims to provide a computerized digital method (CAD-CAM) that contains two forms of individualized transfer of the condylar trajectory, on the one hand, using the structural basis of the glenoid cavity obtained from volumetric Cone Beam Computed Tomography (CBCT), and on the other hand, the condylar guides of the virtual dental articulators with their condyles, through the trajectories obtained by means of magnetic resonance imaging (MRI), digital scanning and/or sensors Object tracking through specialized software cameras, generating three guides (two condylar and one incisal), where the traces of the mandibular trajectories will remain for subsequent 3D printing.

Once the volumetric model of the patient's skull has been obtained, it is necessary to carry out individualized movements of the upper digital teeth with respect to their glenoid cavities and the lower digital teeth with respect to their condyles, obtained from digital scanning and/or from the monitoring and alignment of the movements of the patient's dental structures (laterotrusion, protrusion, retrusion and opening). Resulting in a trajectory in the virtual space formed between the condylar structure and its glenoid cavity by the collision between these two objects. In the case of the already known dental articulators, it is possible to do so between the virtual condyles of the articulator and a new virtual structure that will represent the condylar guides. Where it is possible to obtain a sliding model between the trajectory obtained and the condyles with respect to their glenoid cavities in both cases, resulting in a structure in which the specific trajectories of each temporomandibular joint (TMJ) are recorded, which can be printed in third dimension (3D) and placed on any dental articulator.

To obtain these intermaxillary movements, it is necessary to record the movements of the jaw (anterior guide, canine guides, centric relation and habitual occlusion) either by scanning with a dental scanner or by monitoring with accessories that use movement tracking, through a camera or any other means that allows the monitoring of said movements, for example magnetic resonance imaging, resulting in repositioning the condyles with respect to their glenoid cavities that will serve to generate a new record of movement and position. condylar with respect to its glenoid cavity, which will allow the generation of a new trajectory both interdentally and the temporomandibular joints, resulting in a modification of said trajectories for the benefit and treatment of patients' temporomandibular disorders, or for the modification of dental structures or any digital dental procedure.

Having as its primary objective an individualized movement of each patient, unlike the already known dental articulators that use averaged trajectories and specifying said intermaxillary movements, which can be measurable and modifiable virtually.

### BACKGROUND

The dental articulator is defined as “a rigid mechanical device to which the vertical and horizontal relations of the maxillo-mandibular relationship are transferred, the definitive working models are attached to the bases and rollers, and are fixed on its upper and lower branches that respectively represent the maxilla and mandible; they also reproduce the mandibular positions and movements through the condylar attachments that represent the temporomandibular joints” Ozawa Total Prosthodontics, 1995, pp 320 chapter XXIV Jose Y. Ozawa Degushi, National Autonomous University of Mexico.

Among the patent documents that exist on the subject, we can cite the following:

United States patent application US20180153658A1 refers to an anatomical dental articulator that provides the replica of the glenoid cavity and condyles obtained by means of CBCT on a predetermined articulator for 3D printing. But it does not have individualized condylar guides that allow the movements of each patient to be transferred.

The Mexican patent application MX/a/2018/008911 refers to an articulator for dental use that incorporates a 3D volumetric computed tomography to transfer the replica temporomandibular joint, occlusal plane, and digital acquisition method. But it does not present a modifiable system of said trajectories.

But it does not have the guides that occur between the space of the condyles and the glenoid cavities.

The Mexican patent application MX/a/2018/008911 refers to an articulator for dental use that incorporates a 3D volumetric computed tomography to transfer the replica temporomandibular joint, occlusal plane, and digital acquisition method. But it does not have an incisal guide that allows mandibular movements to be reproduced.

### BRIEF DESCRIPTION OF THE FIGURES

FIG. 1 represents a front view of both devices where on the left side we present the digital dental models integrated into the TMJ (condyles and glenoid cavities) and on the right side we can see the digital dental models on the virtual condyles of the articulator.

FIG. 2 is a right lateral view of the components necessary to generate the condylar trajectory guides.

FIG. 3 represents a front view of both digital devices in which we can observe a transparent trajectory of the incisal guide and the condyles at the moment of opening, which through the collision generates a trajectory on the incisal guide.

FIG. 4 is a right ¾ lateral view that allows visualization of the trajectory generated between the digital stem and the incisal guide from an initial position to a final position, by tracking the digital scan in the patient's opening on both virtual devices.

FIG. 5 is a side view that represents the protusive movement that allows visualization of the trajectory generated between the digital stem and the incisal guide from an initial position to a final position, by tracking the digital scan in the patient's opening on both virtual devices.

FIG. 6 is a left side view that represents the protrusive movement that allows visualizing the trajectory generated between the digital stem and the incisal guide from a starting position to a final position, by tracking the patient's protrusive digital scan on both virtual devices. FIG. 7 is a frontal view that represents the movement in right laterality that allows visualizing the trajectory generated between the digital stem and the incisal guide from an initial position to a final position, by following the digital scan in the patient's right laterality, where, in addition, it generates a trajectory between the condyle and the left condylar guide. and the digital stem against the incisal guide on both virtual devices.

FIG. 8 is a frontal view that represents the movement in left laterality that allows visualizing the trajectory generated between the digital stem and the incisal guide from an initial position to a final position, by following the digital scan in the patient's left laterality, where, in addition, it generates a trajectory between the condyle and the right condylar guide. and the digital stem against the incisal guide on both virtual devices.

FIG. 9 is a ¾ view that represents the movement in right laterality that allows visualizing the trajectory generated between the digital stem and the incisal guide from an initial position to a final position, by following the digital scan in the patient's right laterality, where, in addition, it generates a trajectory between the condyle and the left condylar guide. and the digital stem against the incisal guide on both virtual devices.

FIG. 10 is a ¾ view that represents the movement in left laterality that allows visualizing the trajectory generated between the digital stem and the incisal guide from an initial position to a final position, by following the digital scan in the patient's left laterality, where, in addition, it generates a trajectory between the condyle and the right condylar guide. and the digital stem against the incisal guide on both virtual devices.

FIG. 11 represents an upper front view of the incisal guide individually in which we can observe the trajectories generated by the collision of the digital stem on the incisal guide.

FIG. 12 is an upper right isometric view that allows us to observe the trajectories generated by the digital shank on the incisal guide.

FIG. 13 is a lower view of the left and right condylar guides, which allows us to visualize the trajectories that generated the collision of the condyles on the condylar guides in the left and right laterality movements, and protusive movement.

FIG. 14 represents an individualized lower front ¾ right view of the condylar guides, which allows us to visualize the trajectories that generated the collision of the condyles on the condylar guides in the left and right laterality movements. and protusive movement.

FIG. 15 is a lower view of the upper components of both devices in which on the left side we can see the digital upper dental model with respect to its condylar guides and digital stem, located in a three-dimensional way and on the right side we can see the upper components of the virtual device of the digital upper dental model with respect to its glenoid cavities obtained from a CBCT tomography overlapping the condylar guides obtained from the condylar trajectories.

FIG. 16 is an upper front view where on the left side we can see the components of the virtual device whose condyles correspond to a virtual dental articulator and the lower digital dental model is located three-dimensionally with respect to them and the lower guide, on the right side we can see the condyles obtained from the volumetric tomography and the digital dental model located in a three-dimensional way with respect to the guide Incisal.

FIG. 17 is a top view of both devices where on the left side we can see the trajectories generated in the incisal guide of both.

FIG. 18 is a lower view of both devices where we can see on the left side the condylar guides with their condylar trajectories and on the right side these guides overlap over the glenoid cavity.

### DETAILED DESCRIPTION OF THE INVENTION

The present invention consists of a computerized digital CAD-CAM method that allows the integration of the individualized mandibular movements obtained from each patient for their reproduction in the devices colloquially known as dental articulators. With this computerized digital method, it will be possible to personalize these movements more precisely. This computerized digital method can be executed through two ways, on the one hand, the integration of digital dental models to the TMJ of the volumetric tomography and on the other hand, the integration of digital dental models to the components that represent the TMJ in the virtual articulators (FIG. 1), replacing the condylar guides to be 3D printed and placed on its corresponding physical articulator or on the printing of glenoid cavities to reproduce the trajectory of jaw movements.

Option 1. Using condyles and glenoid cavity from CBCT converted to STL volume files.

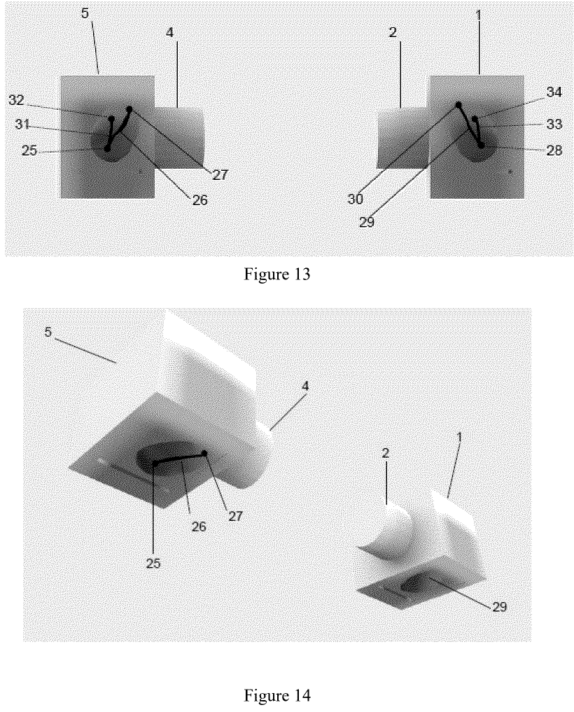

The condyles (6) (12) will produce a collision generated by interdental movements by aligning the scans of the movements of the digital dental models (8) (9) previously positioned on the patient's volumetric tomography against the condylar bases (1) (5) interposed between the glenoid cavities (7) (11) and the condyles (6) (12), the condylar bases (1) (5) being the only modifiable ones, which will be printed on the three-dimensional glenoid cavities (7) (11), obtained from volumetric tomography, generating two left and right condylar trajectory guides (26) (29), where this structure will subsequently be digitally deformed with the movements of the condylar structures (6) (12) generating a trajectory on the aforementioned “condylar bases”. (1) (5) (FIGS. 13 and 14)

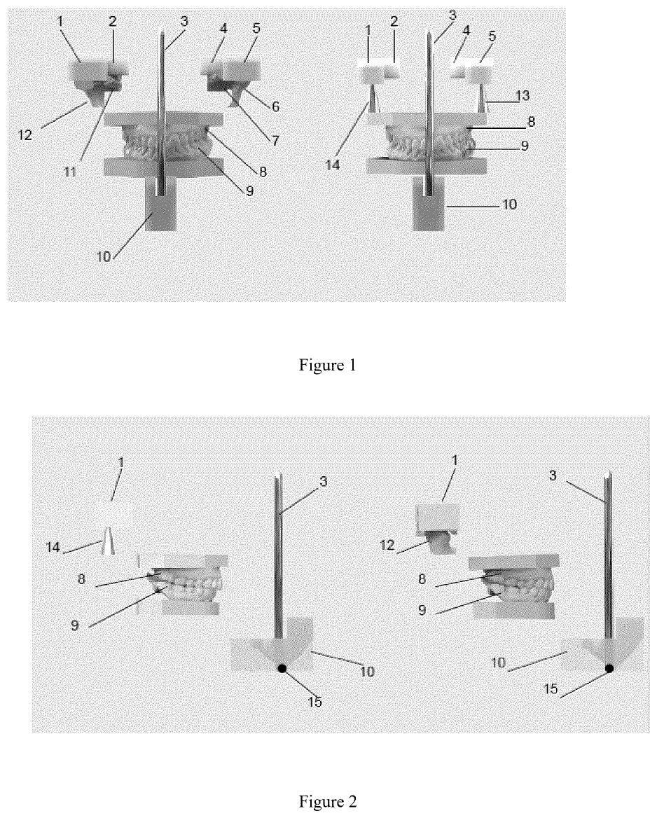

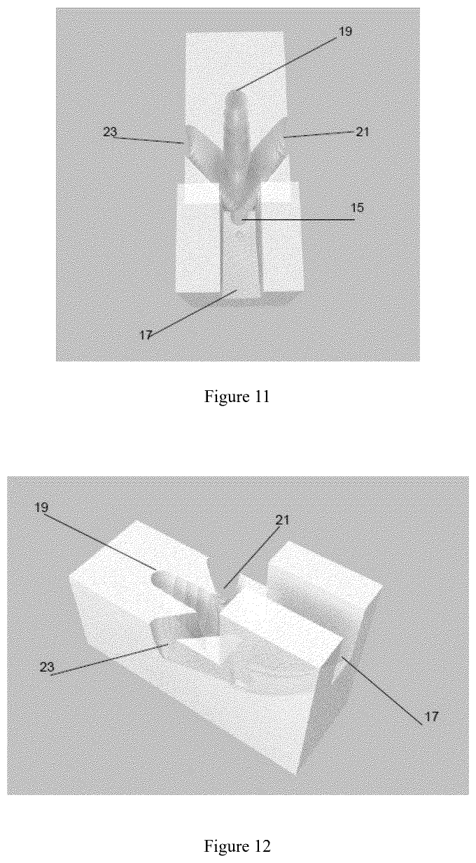

Similarly, a digital shank (3) that allows a deformation to be generated on an “incisal guide” (10), by means of a collision between the digital shank (3) and the incisal guide (10), (FIG. 2) where the mandibular movements will be printed on the incisal guide (10) digitally. It integrates the trajectories of the three-dimensional mandibular movements in opening (17), protrusive (19), right laterality (21) and left laterality (23) from an initial position in occlusion (15) (16). (FIGS. 11 and 12)

NOTE: Once these three condylar guides (left, right and incisal) have been generated, they can be exported to be 3D printed. The initial position of the digital stem and condyles can be in usual occlusion, centric relationship, or both, as desired by the operator. The trajectories will be described as follows:

### Incisal Guide Paths:

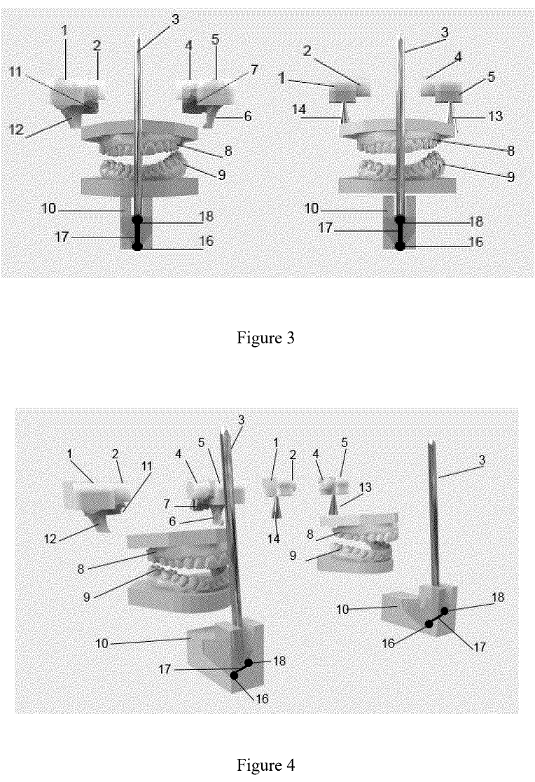

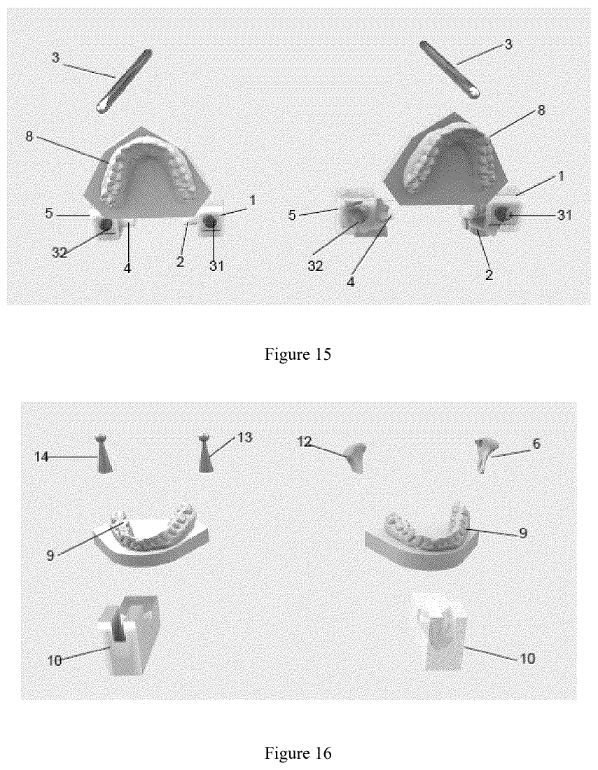

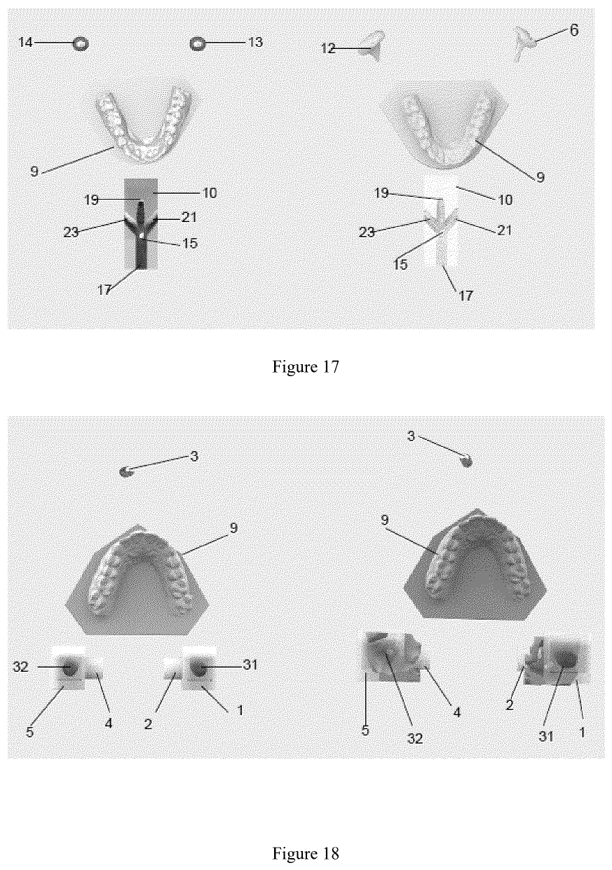

The opening path (17), for this record it is necessary to group the upper digital dental model (8), the digital stem (3) and the glenoid cavities CBCT (7) (11), and independently we will group the lower digital dental model (9) (FIGS. 16 and 17) and the incisal guide (10), on the right and left CBCT table and condyles (6) (12), then we integrated the digital dental scan of the movement in opening and through alignment, we integrated the upper digital dental model (8) (FIGS. 15 and 18) on top of the dental scan model, from an initial position in occlusion (15) (16) to a final position in opening (18), which will result in a trajectory (17) (FIGS. 11 and 12). generating a collision between the digital stem (3) and the incisal guide. (10) (FIGS. 3 and 4).

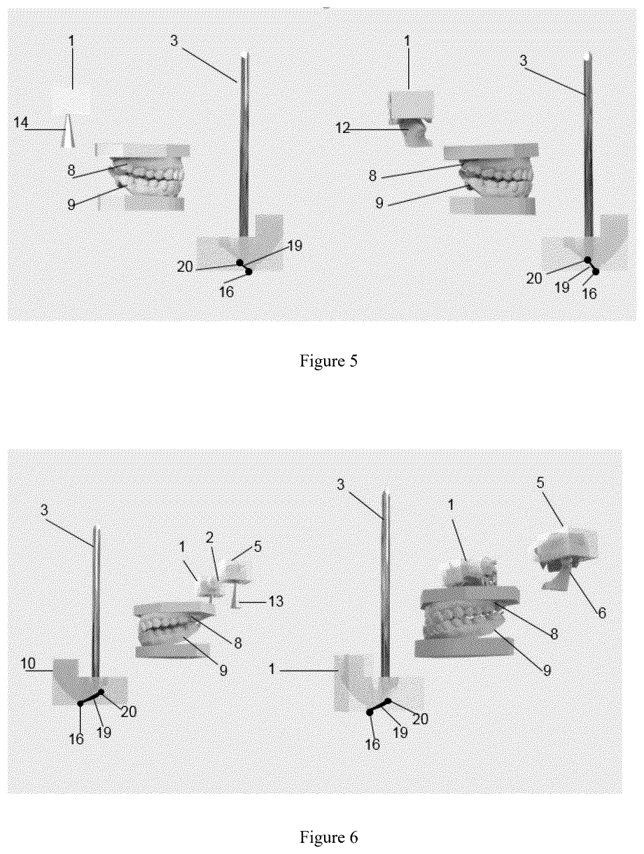

Career in protrusive (19); for this registry it is necessary to group the upper digital dental model (8) (FIGS. 15 and 18), the digital stem (3) and the glenoid cavities CBCT (7) (11), and independently we will group the lower digital dental model (9) (FIGS. 16 and 17) and the incisal guide (10), on the right and left CBCT table and condyles (6) (12), Subsequently, we integrated the digital dental scan of the protusive movement and through alignment, we integrated the upper digital dental model (8) on the dental scan model, from an initial position in occlusion (15) (16) to a final position in protrusive (20), which will result in a trajectory (19) (FIGS. 11 and 12). generating a collision between the digital stem (3) and the incisal guide. (10) (FIGS. 5 and 10).

Right Laterality Trajectory (21); for this registry it is necessary to group the upper digital dental model (8), the digital stem (3) and the glenoid cavities CBCT (7) (11), and independently we will group the lower digital dental model (9) and the incisal guide (10), on the right and left CBCT table and condyles (6) (12), then we integrate the digital scan of the movement in right laterality and by means of alignment, We integrated the upper digital dental model (8) on top of the dental scan model, from an initial position in occlusion (15) (16) to a final position in right laterality (22), which will result in a trajectory (21) (FIGS. 11 and 12), generating a collision between the digital stem (3) and the incisal guide. (10) (FIGS. 6 and 7).

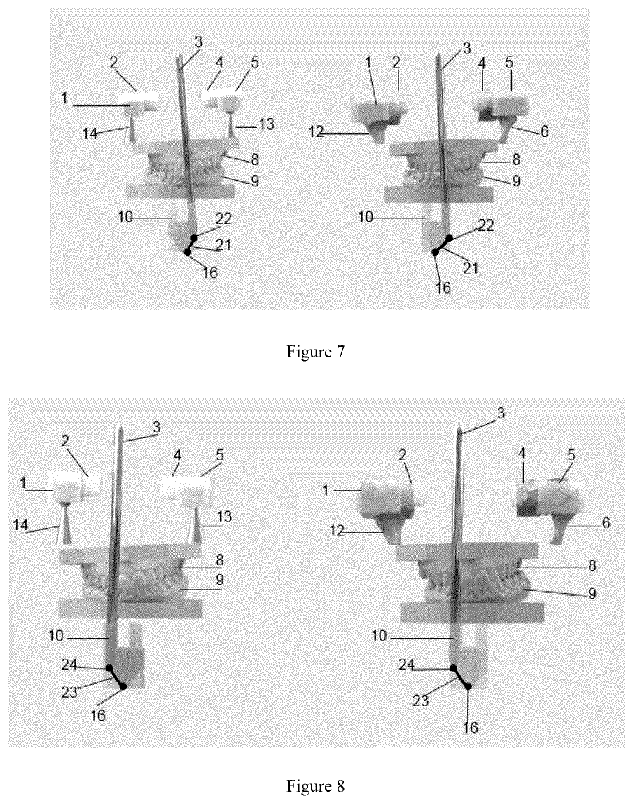

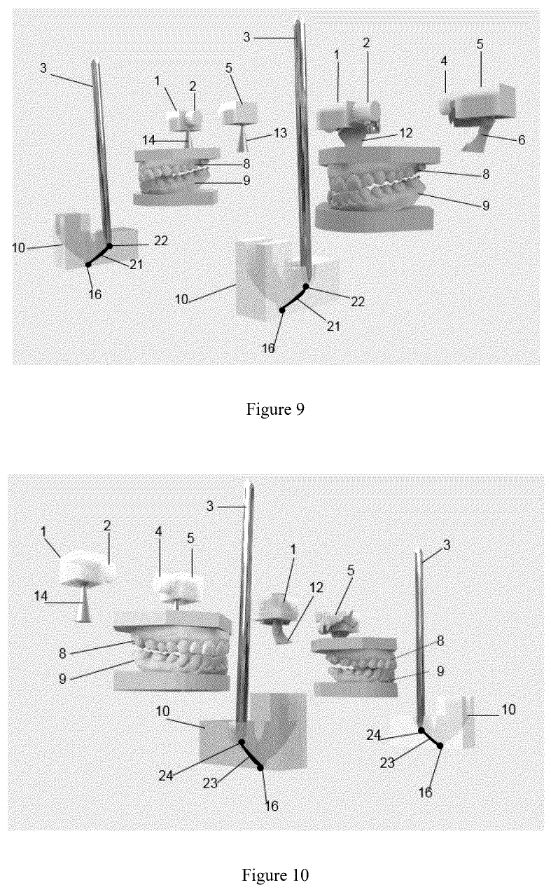

Left laterality trajectory (23); for this registry it is necessary to group the upper digital dental model (8), the digital stem (3) and the glenoid cavities CBCT (7) (11), and independently we will group the lower digital dental model (9) and the incisal guide (10), on the right and left CBCT table and condyles (6) (12), then we integrate the digital scan of the movement in left laterality and by means of alignment, We integrated the upper digital dental model (8) on top of the dental scan model, from an initial position in occlusion (15) (16) to a final position in left laterality (24), which will result in a trajectory (23) (FIGS. 11 and 12), generating a collision between the digital stem (3) and the incisal guide. (10) (FIGS. 8 and 9).

### Condylar Trajectories:

Trajectory of the left condyle (29): for this registration it is necessary to group the upper digital dental model (8) integrated into the occlusal plane of the volumetric tomography with the glenoid cavities CBCT (7) (11), the digital stem (3) and the base of the left condylar guide (5) below the left glenoid cavity CBCT (7), in addition, we will independently group the inferior digital dental model (9) integrated into the CBCT tomography, the incisal guide (10) and the CBCT condyles (6) (12) converted to STL volume files, then we integrated the digital dental scan of the movement in right laterality and by means of alignment, we integrated the upper digital dental model (8) on the model of the digital dental scan, from an initial position in occlusion (15) (16) to a final position in right laterality (22), which will give us a trajectory, generating a collision between the left condyle CBCT (6) and the base of the left condylar guide (5). It will be necessary to incorporate the right laterality obtained from the digital dental scan, in which it will be integrated into the left glenoid cavity CBCT (7) to be 3D printed, the left condyle CBCT (6) will generate a collision and in turn a trajectory, having as its initial position the occlusion (15) (16) and a final position of the right canine guide. which in turn will produce a final position of the right condyle (27) generating a trajectory of the left condyle CBCT (7) on the basis of the left condylar guide (5). (FIG. 14)

Trajectory of the right condyle (26): for this registration it is necessary to group the upper digital dental model (8) integrated into the occlusal plane of the volumetric tomography with the glenoid cavities CBCT (7) (11), the digital stem (3) and the base of the right condylar guide (1) below the right glenoid cavity CBCT (11), in addition, we will independently group the inferior digital dental model (9) integrated into the CBCT tomography, the incisal guide (10) and the CBCT condyles (6) (12) converted to STL volume files, then we integrated the digital dental scan of the movement in left laterality and by means of alignment, we integrated the upper digital dental model (8) on the model of the digital dental scan, from an initial position in occlusion (15) (16) to a final position in right laterality (22), which will give us a trajectory, generating a collision between the right condyle CBCT (12) and the base of the right condylar guide (1). It will be necessary to incorporate the left laterality obtained from the digital dental scan, in which it will be integrated into the right glenoid cavity CBCT (11) to be 3D printed, the right condyle CBCT (12) will generate a collision and in turn a trajectory, having as its initial position the occlusion (15) (16) and a final position of the left canine guide. which in turn will produce a final position of the left condyle (30) generating a trajectory of the right condyle on the basis of the right condylar guide. (FIG. 14)

Trajectory of the right condyle in protusive (31): for this record, it is necessary to group the superior digital dental model (8) integrated into the occlusal plane of the volumetric tomography with the glenoid cavities CBCT (7) (11), the digital stem (3) and the base of the right condylar guide (1) below the right glenoid cavity CBCT (11), in addition, we will independently group the lower digital dental model (9) integrated into the CBCT tomography, the incisal guide (10) and the CBCT condyles (6) (12) converted to STL volume files, then we integrate the digital dental scan of the protrusive movement and through alignment, we integrate the upper digital dental model (8) on the model of the digital dental scan, from an initial position in occlusion (15) (16) to a final position of the right condyle in protusive (32), which will give us a trajectory, generating a collision between the right condyle CBCT (12) and the base of the right condylar guide (1). It will be necessary to incorporate the right glenoid cavity CBCT (11) to be 3D printed and the right condyle CBCT (12), this will generate a collision and in turn a trajectory, having as an initial position the occlusion (15) (16) and a final position of the right condyle in protrusive (32), generating a trajectory of the right condyle on the basis of the right condylar guide. (FIG. 14)

Trajectory of the left condyle in protusive (33): for this recording it is necessary to group the superior digital dental model (8) integrated into the occlusal plane of the volumetric tomography with the glenoid cavities CBCT (7) (11), the digital stem (3) and the base of the left condylar guide (5) below the left glenoid cavity CBCT (7), in addition, we will independently group the lower digital dental model (9) integrated to the CBCT tomography, the incisal guide (10) and the CBCT condyles (6) (12) converted to STL volume files, then we integrate the digital dental scanning of the movement in protrusive and through alignment, we integrate the superior digital dental model (8) on the digital dental scan model, from an initial position in occlusion (15) (16) to a final position of the left condyle in protusive (34), which will give us a trajectory, generating a collision between the left condyle CBCT (6) and the base of the left condylar guide (5). It will be necessary to incorporate the left glenoid cavity CBCT (7) to be 3D printed and the left condyle CBCT (6), this will generate a collision and in turn a trajectory, having as an initial position the occlusion (15) (16) and a final position of the left condyle in protusive (34) generating a trajectory of the left condyle on the basis of the left condylar guide. (FIG. 14) NOTE: to generate any of these trajectories it is possible to integrate several scans to each one at different points of the trajectory.

Description of the components of option 1:

Condyles (6) (12) are three-dimensional structures whose shape represents the three-dimensional volume obtained from volumetric tomography of the condyles. The condylar bases (1) (5) are a three-dimensional cuboidal structure that can be integrated using the glenoid cavities as a base. The digital stem (3) is a three-dimensional cylindrical elongated structure that can be integrated into the upper branch of an articulator or incorporated into three-dimensional movements by grouping the upper teeth and their glenoid cavities. The incisal guide (10) is a three-dimensional cuboidal structure whose shape can be integrated into an incisal table.

In order to perform this method, it is necessary to align the digital dental models (8) (9) to a CBCT volumetric tomography, as well as the conversion of the DICOM files to STL files and the grouping of the upper dental model with respect to its glenoid cavities and the digital stem, as well as the lower dental model with respect to its condyles and the incisal guide to virtually separate the mandible from the maxilla.

In addition, it integrates the digital scanning of the interdental movements of: laterotrusion, protrusion, retrusion and opening, as well as the positions of centric relationship and habitual occlusion, obtained by the records of the digital scan or the monitoring of these movements through the already known attachments, for example, magnetic resonance imaging. The procedure is performed taking as a reference the scanning of the occlusion or the three-dimensional recording of the usual occlusion and the alignment of the models with their respective laterotrusion, protrusion and aperture movements, generating a collision on the left condylar guidewire, right condylar guide and the incisal guide.

Option 2. Using the virtual components of a conventional dental articulator. The condyles of a virtual articulator (13) (14) that have a spherical shape will produce a collision generated by interdental movements by aligning the scans of the movements of the digital dental models (8) (9) previously positioned to the occlusal plane of the virtual articulator obtained from the patient, against the condylar bases (1) (5), which will replace the condylar guides of the dental articulator, which will be modified by the spherical condylar structures (13) (14), with the condylar bases being the only ones that can be modified, generating two left and right condylar trajectory guides (26) (29), where later this structure will be digitally deformed with the trajectories of the condyles (13) (14) generating a trajectory on the aforementioned “condylar bases”. (1) (5) (FIGS. 13 and 14)

In the same way, a digital stem (3) that allows a deformation to be generated on an “incisal guide” (10) incorporated on the incisal guide of conventional articulators, generating a collision between the digital stem (3) and the incisal guide (10), where the mandibular movements will be printed on the three-dimensional object. The result was an incisal guide (10) that integrates the three-dimensional mandibular movements of the opening trajectory (17), protrusive trajectory (19), right laterality trajectory (21), and left laterality trajectory (23). (FIGS. 11 and 12)

NOTE: Once these three condylar guides (left, right and incisal) are generated, they can be exported to be 3D printed. The initial position of the digital stem and condyles can be in usual occlusion, centric relationship, or both, as desired by the operator.

The trajectories will be described as follows:

### Incisal Guide Paths:

The opening path (17) For this record, it is necessary to group the upper digital dental model (8), the digital stem (3) and the condylar guides of the virtual articulator, in addition, we will independently group the lower digital dental model (9), the incisal guide (10), on the table and condyles of the virtual articulator (13) (14), then we integrate the digital dental scan of the movement in opening and through alignment, and we integrated the upper digital dental model (8) (FIGS. 15 and 18) on top of the dental scan model, from an initial position (15) (16) to a final position in opening (18), which will give us a trajectory (17) (FIGS. 11 and 12), generating a collision between the digital stem (3) and the incisal guide (10). (FIGS. 3 and 4)

Career in protrusive (19); for this registration it is necessary to group the upper digital dental model (8) (FIGS. 15 and 18), the digital stem (3) and the condylar guides of the virtual articulator, in addition, we will independently group the lower digital dental model (9) (FIGS. 16 and 17), the incisal guide (10), on the table and condyles of the virtual articulator (13) (14), Subsequently, we integrated the digital dental scan of the protrusive movement and through alignment, we integrated the upper digital dental model (8) on top of the dental scan model, from an initial position (15) (16) to a final position in protrusive (20), which will give us a trajectory (19) (FIGS. 11 and 12), generating a collision between the digital stem (3) and the incisal guide (10). (FIGS. 5 and 10)

Right Laterality Trajectory (21); For this record, it is necessary to group the upper digital dental model (8), the digital stem (3) and the condylar guides of the virtual articulator, in addition, we will independently group the lower dental model (9), the incisal guide (10), on the table and condyles of the virtual articulator, then we integrate the digital dental scan of the movement in right laterality and through alignment, we integrated the upper digital model (8) on top of the dental scan model, from an initial position (15) (16) to a final position of right laterality (22), which will give us a trajectory (21) (FIGS. 11 and 12), generating a collision between the digital stem (3) and the incisal guide (10). (FIGS. 6 and 7)

Left laterality trajectory (23); For this record, it is necessary to group the upper digital dental model (8), the digital stem (3) and the condylar guides of the virtual articulator, in addition, we will independently group the lower digital dental model (9) and the incisal guide (10), on the table and condyles of the virtual articulator (13) (14), then we integrate the digital dental scan of the movement in left laterality and through alignment, we integrated the upper digital dental model (8) on top of the dental scan model, from an initial position (15) (16) to a final position of left laterality (24), which will give us a trajectory (23) (FIGS. 11 and 12), generating a collision between the digital stem (3) and the incisal guide (10). (FIGS. 8 and 9)

### Condylar Trajectories:

Left condyle trajectory (29): for this record it is necessary to group the upper digital dental model (8), the digital stem (3) and the left condylar guide base of the virtual articulator (5), in addition, we will independently group the lower digital dental model (9) and the incisal guide (10), on the table and condyles of the virtual articulator (13) (14), Subsequently, we integrated the digital dental scan of the movement in right laterality and through alignment, we integrated the superior digital dental model (8) on top of the digital dental scan model, from an initial position in occlusion (15) (16) to a final position of right laterality (22), which will give us a trajectory, generating a collision between the left condyle of the virtual articulator (13) and the base of the left condylar guide (5). It will be necessary to incorporate the right laterality obtained from the digital dental scan, in which it will be necessary to digitally replace the left condylar guide of the virtual articulator with the base of the left condylar guide (5) in which the left condyle of the virtual articulator (13) will generate a collision and in turn a trajectory, having as its initial position the occlusion (15) (16) which is the initial position of the left condyle (28) and a final position of the right canine guide that in turn will produce a final position of the right condyle (27), generating a trajectory of the left condyle on the base of the left condylar guide, which must be oriented horizontally and parallel to the horizontal branch of the virtual articulator. The left clamping base (4) must be digitally adapted to the desired upper horizontal branch of the virtual articulator. (FIG. 14)

Trajectory of the right condyle (26): for this registration it is necessary to group the upper digital dental model (8), the digital stem (3) and the right condylar guide base of the virtual articulator, in addition, we will independently group the lower digital dental model (9) and the incisal guide (10), on the table and condyles of the virtual articulator (13) (14), Subsequently, we integrated the digital dental scan of the movement in left laterality and through alignment, we integrated the superior digital dental model (8) on top of the digital dental scan model, from an initial position in occlusion (15) (16) to a final position of left laterality (24), which will give us a trajectory, generating a collision between the right condyle of the virtual articulator (14) and the base of the right condylar guide (1). It will be necessary to incorporate the left laterality obtained from the digital dental scan, in which it will be necessary to digitally replace the right condylar guide of the virtual articulator with the base of the right condylar guide (1) in which the right condyle of the virtual articulator (14) will generate a collision and in turn a trajectory, having as its initial position the occlusion (15) (16) which is the initial position of the right condyle (25) and a final position of the left canine guide that in turn will produce a final position of the right condyle (27), generating a trajectory of the right condyle of the virtual articulator (14) on the basis of the right condylar guide (1), which must be oriented horizontally and parallel to the horizontal branch of the virtual articulator. The right clamping base (2) must be digitally adapted to the desired upper horizontal branch of the virtual articulator. (FIG. 14)

Left condyle trajectory in protrusive (33): for this registration it is necessary to group the upper digital dental model (8), the digital stem (3) and the left condylar guide base of the virtual articulator (5), in addition, we will independently group the lower digital dental model (9) and the incisal guide (10), on the table and condyles of the virtual articulator (13) (14), Subsequently, we integrated the digital dental scan of the protusive movement and through alignment, we integrated the superior digital dental model (8) on top of the digital dental scan model, from an initial position in occlusion (15) (16) to a final position of the left condyle in protusive (34), which will give us a trajectory, generating a collision between the left condyle of the virtual articulator (13) and the base of the left condylar guide (5). The left condyle of the virtual articulator (13) will generate a collision and in turn a trajectory, having as its initial position the occlusion (15) (16) and a final position of the left condyle in protrusive (34), generating a trajectory of the left condyle on the basis of the left condylar guide (5), which must be oriented horizontally and parallel to the horizontal branch of the virtual articulator. The left clamping base (4) must be digitally adapted to the desired upper horizontal branch of the virtual articulator. (FIG. 14)

Trajectory of the right condyle in protusive (31): for this registration it is necessary to group the upper digital dental model (8), the digital stem (3) and the right condylar guide base of the virtual articulator (1), in addition, we will independently group the lower digital dental model (9) and the incisal guide (10), on the table and condyles of the virtual articulator (13) (14), Subsequently, we integrated the digital dental scan of the protusive movement and through alignment, we integrated the superior digital dental model (8) on the model of the digital dental scan, from an initial position in occlusion (15) (16) to a final position of the right condyle in protusive (32), which will give us a trajectory, generating a collision between the right condyle of the virtual articulator (14) and the base of the right condylar guide (1).

The right condyle of the virtual articulator (14) will generate a collision and in turn a trajectory, having as its initial position the occlusion (15) (16) and a final position of the right condyle in protusive (32), generating a trajectory of the right condyle on the basis of the right condylar guide (1), which must be oriented horizontally and parallel to the horizontal branch of the virtual articulator. The right clamping base (2) must be digitally adapted to the desired upper horizontal branch of the virtual articulator. (FIG. 14)

NOTE: to generate any of these trajectories it is possible to integrate several scans to each one at different points of the trajectory.

1. Eight trajectory guides; two condylar guides in a quadrangular shape that corresponds to the left condylar base (1) on whose lower face it contains a groove in the shape of a “V” that represents the trajectories of left protrusive (33) and left laterality (29), with an initial position of the left condyle (28) and the final position of the trajectory in left laterality (30) and the final position in protrusive (34). A right condylar base (5) on the underside of which contains a “V”-shaped groove that represents the trajectories of right protrusive (31) and right laterality (26), the initial position of the right condyle (25), the final position of the trajectory in right laterality (27) and the final position in protrusive is (32). A quadrangular-shaped incisal guide whose upper face contains four grooves; a “V”-shaped groove, which corresponds to the trajectory of right laterality (21) and the trajectory of left laterality (23), both starting from an initial position in occlusion (15). A straight line that corresponds to the protrusive trajectory (19) and the aperture trajectory (17), both starting from the initial occlusion position (15).
